(19) United States
(12) Patent Application Publication
(10) Pub. No.: US 2006/0210708 A1
(43) Pub. Date: Sep. 21, 2006

(54) Manufacturing method of color filter panel and manufacturing method of liquid crystal display including color filter panel

(75) Inventor: Soo-Guy Rho, (US)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/385,966

(22) Filed: Mar. 21, 2006

(30) Foreign Application Priority Data
Mar. 21, 2005 (KR) 10-2005-0023118

(51) Int. Cl. B05D 5/06; B05D 5/12; B05B 13/02

(52) U.S. Cl. 427/162; 427/58; 118/300; 118/305; 118/46

(57) ABSTRACT

A method of manufacturing a color filter panel using an inkjet printing device including a stage and an inkjet head comprises mounting a flexible substrate on the stage, forming at least one alignment key and a light blocking member having a plurality of openings on the flexible substrate, aligning the inkjet head with the stage on the basis of the at least one alignment key, and ejecting ink through the inkjet head into the openings of the light blocking member to form color filters.

### CROSS-REFERENCE TO RELATED APPLICATION

This application claims priority to Korean Patent Application No. 10-2005-0023118 filed on Mar. 21, 2005, the content of which is incorporated by reference herein in its entirety.

### BACKGROUND OF THE INVENTION

(a) Technical Field

The present disclosure relates to a manufacturing method of a color filter panel, and more particularly to a manufacturing method of a liquid crystal display including the color filter panel.

(b) Discussion of Related Art

A liquid crystal display (LCD) is a widely-used flat panel display that includes a pair of panels comprising field generating electrodes and a liquid crystal (LC) layer disposed between the pair of panels. The LC layer has dielectric anisotropy.

The field generating electrodes include a plurality of pixel electrodes connected to switching elements such as thin film transistors (TFTs) and a common electrode covering an entire surface of a panel. Data voltages are applied to the pixel electrodes, and a common voltage is applied to the common electrode. A pair of field generating electrodes that generate an electric field in cooperation with each other and an LC layer disposed therebetween are referred to as an LC capacitor.

Voltages are applied to the field generating electrodes to generate an electric field in the LC layer, and the strength of the electric field can be controlled by adjusting the voltages across the LC capacitor. Since the electric field determines the orientations of LC molecules and the molecular orientations determine the transmittance of light passing through the LC layer, the light transmittance is adjusted by controlling the applied voltages. By adjusting the light transmittance, desired images are obtained.

In the liquid crystal display, substrates of two panels comprise a material which is transparent and not flexible such as, for example, glass. However, recently, flexible display devices which use, for example, plastic substrates have been developed.

When the flexile display devices are manufactured, misalignment between patterns respectively formed on laminated layers occurs. That is, due to, for example, heat and humidity, dimensions of the plastic substrates are changed during thermal treatment processes. Accordingly, an alignment error between a mask aligned for patterning and the transformed substrate occurs. The alignment error causes misalignment between the patterns formed by photolithography. The panel having the common electrode includes color filters representing one of three primary color such as red, green, and blue. The misalignment occurs frequently in the panel having the color filters because when patterns of respective color filters for red, green, and blue are present, dimensions of the plastic substrate are changed.

### SUMMARY OF THE INVENTION

According to an embodiment of the present invention, a manufacturing method of a color filter panel using an inkjet printing device that includes a stage and an inkjet head comprises mounting a flexible substrate on the stage, forming at least one alignment key and a light blocking member having a plurality of openings on the flexible substrate, aligning the inkjet head with the stage on the basis of the at least one alignment key, and ejecting inks through the inkjet head into the openings of the light blocking member to form color filters.

The flexible substrate may include a plurality of unit cells, and the at least one alignment key is formed around every unit cell.

The flexible substrate may include a plurality of unit cells, and the at least one alignment key is formed on an edge of every unit cell.

The alignment of the inkjet head with the stage may be repeated for every unit cell.

The color filters may include color filters for red, green, and blue and at the least one alignment key may be formed based on the color filters for red, green, and blue, respectively.

The flexible substrate may comprise one material selected from polyacrylate, polyethylene-terephthalate, polyethylene-naphthalate, polycarbonate, polyarylate, polyether-imide, polyethersulfone, or polyimides.

The manufacturing method may further comprise forming an overcoat on the color filters and the light blocking member, and forming a common electrode on the overcoat.

The inkjet head may comprise a plurality of nozzles, and the ink is ejected through the nozzles.

The light blocking member and the at least one alignment key may be formed by photo etching.

The inkjet head may be inclined at a predetermined angle so that an interval between adjacent ink ejected through the inkjet head corresponds a pixel pitch.

According to an embodiment of the present invention, a manufacturing method of a liquid crystal display (LCD) comprises forming a thin film transistor (TFT) array panel, forming a color filter panel opposite the TFT array panel, and injecting a liquid crystal layer between the TFT array panel and the color filter panel. The formation of the color filter panel includes mounting a flexible substrate on the stage, forming at least one alignment key and a light blocking member having a plurality of openings on the flexible substrate, aligning the inkjet head with the stage on the basis of the at least one alignment key, and ejecting ink through the inkjet head into the openings of the light blocking member to form color filters.

The flexible substrate may include a plurality of unit cells, and at least one alignment key is formed around every unit cell.

The flexible substrate may include a plurality of unit cells, and at least one alignment key is formed on an edge of every unit cell.

The alignment of the inkjet head with the stage may be repeated for every unit cell.

The flexible substrate may comprise one material selected from polyacrylate, polyethylene-terephthalate, polyethylene-naphthalate, polycarbonate, polyarylate, polyether-imide, polyethersulfone, and polyimides.

According to an embodiment of the present invention, an inkjet printing device comprises a head unit including an inkjet head for ejecting ink, a transporting unit, coupled with the head unit, for transporting the head unit in a first direction and a second direction, and a stage for receiving a color filter panel having an insulating substrate, the stage transporting the color filter panel in the first direction and the second direction, wherein alignment keys to align the transporting unit with the stage are formed on the insulating substrate.

The first direction and the second direction may be perpendicular to each other.

The inkjet head may be inclined in a predetermined angle.

The alignment keys may be formed in cross shapes.

### BRIEF DESCRIPTION OF THE DRAWINGS

Exemplary embodiments of the present invention can be understood in more detail from the following description taken in conjunction with the accompanying drawings in which:

FIG. 1 is a layout view of a TFT array panel according to an embodiment of the present invention;

FIG. 2 is a layout view of a color filter array panel according to an embodiment of the present invention;

FIG. 3 is a layout view of an LCD according to an embodiment of the present invention;

FIG. 4 is a sectional view of the LCD shown in FIG. 3 taken along the line IV-IV;

FIG. 5 is a sectional views of the LCD shown in FIG. 3 taken along the lines V-V′ and V′-V″;

FIG. 6 illustrates alignment keys formed on a flexible substrate having a plurality of unit cells according to an embodiment of the present invention;

FIG. 7 is a perspective view of an inkjet printing device according to an embodiment of the present invention; and

FIG. 8 is a bottom view of an inkjet head of the inkjet printing device according to an embodiment of the present invention.

### DETAILED DESCRIPTION OF EXEMPLARY EMBODIMENTS

Exemplary embodiments of the present invention are more fully described below with reference to the accompanying drawings. The present invention may be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

Inkjet alignment layer printing apparatuses and printing methods of an alignment layer according to embodiments of the present invention will now be described with reference to the drawings.

Manufacturing methods of a color filter panel and manufacturing methods of an LCD including a color filter panel according to an embodiment of the present invention will also be described.

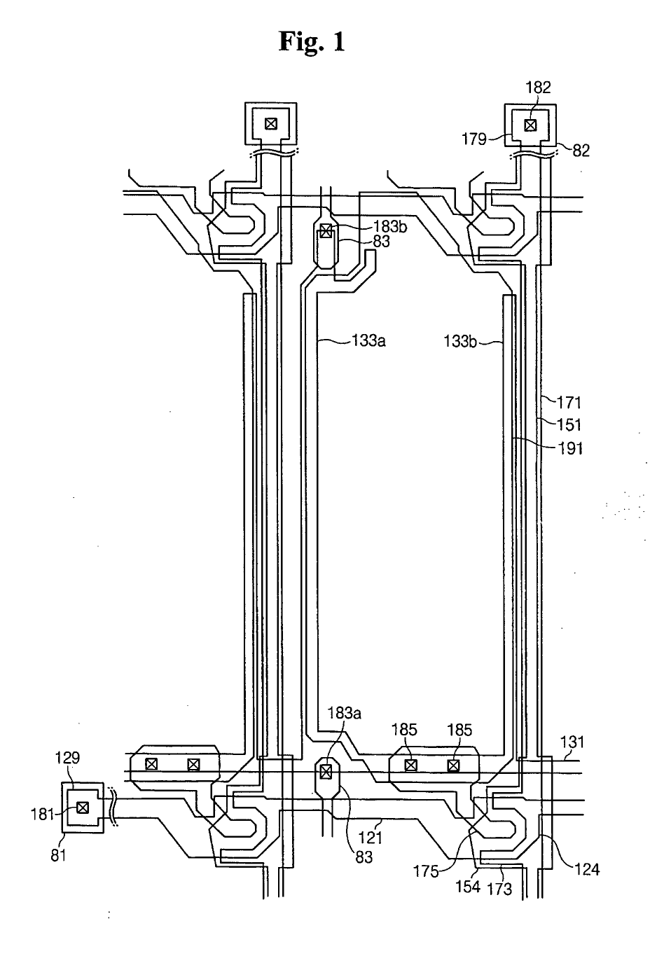

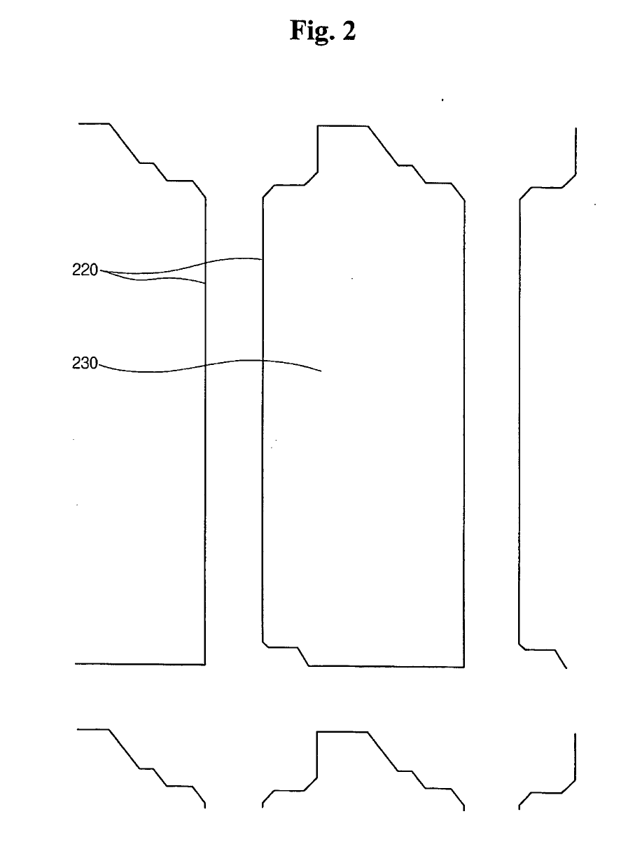

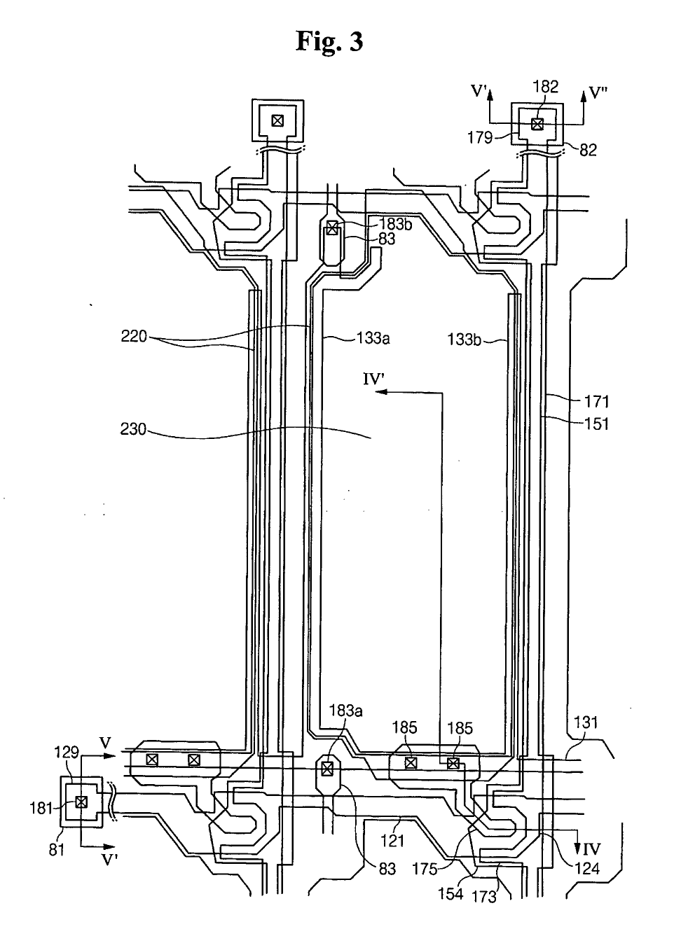

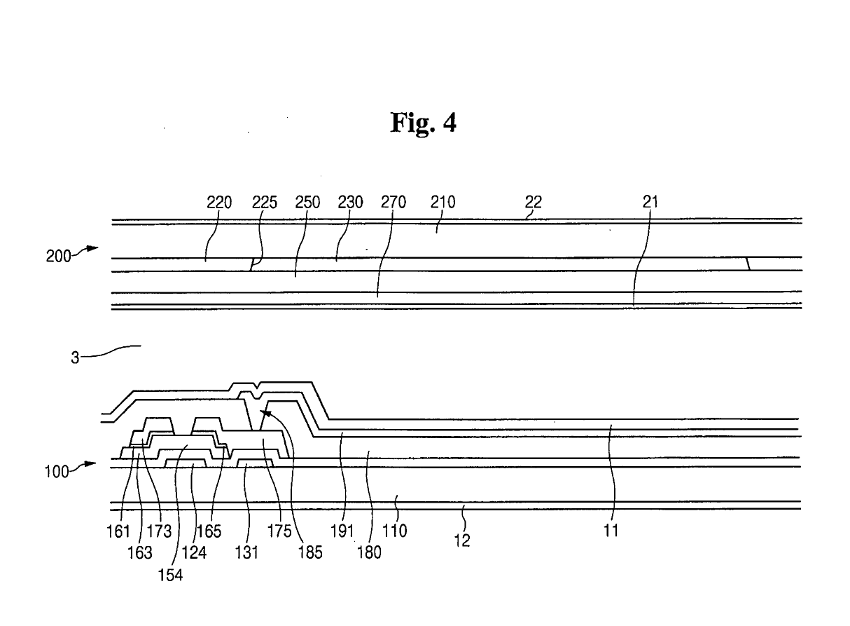

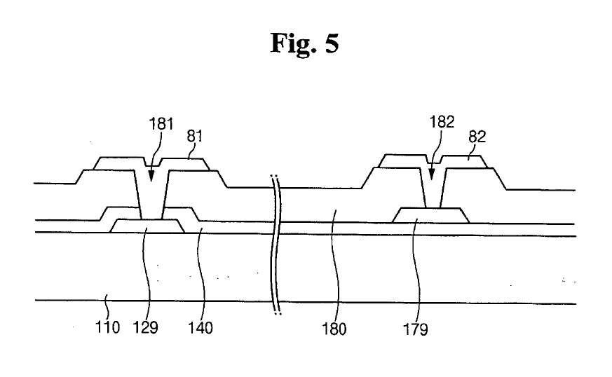

FIG. 1 is a layout view of a TFT array panel according to an embodiment of the present invention; FIG. 2 is a layout view of a color filter array panel according to an embodiment of the present invention; FIG. 3 is a layout view of an LCD according to an embodiment of the present invention; FIG. 4 is a sectional view of the LCD shown in FIG. 3 taken along the line IV-IV; and FIG. 5 is a sectional views of the LCD I shown in FIG. 3 taken along the lines V-V′ and V′-V″.

A liquid crystal display (LCD) according to an embodiment of the present invention includes a TFT array panel 100, a color filter panel 200 opposite the TFT array panel 100, and an LC layer 3 having LC molecules disposed between the two panels 100 and 200.

Referring to FIGS. 1 and 3 to 5, a plurality of gate lines 121 and a plurality of storage electrode lines 131 are formed on an insulating substrate 110.

In an embodiment of the present invention, the insulating substrate 110 comprises a flexible material such as, for example, plastic suitable for manufacturing flexible LCDs. The insulating substrate 110 may include a layer comprising a material selected from polyacrylate, polyethylene-terephthalate, polyethylene-naphthalate, polycarbonate, polyarylate, polyether-imide, polyethersulfone, or polyimides.

The gate lines 121 transmit gate signals and extend substantially in a transverse direction. Each of the gate lines 121 includes a plurality of gate electrodes 124 projecting downward and having an area for contacting another layer or an external driving circuit. A gate driving circuit (not shown) for generating the gate signals may be mounted on a flexible printed circuit (FPC) film (not shown). The FPC film may be attached to the insulating substrate 110, be directly mounted on the insulating substrate 110, or be integrated onto the insulating substrate 110. The gate lines 121 may be connected to a driving circuit that may be integrated onto the insulating substrate 110.

The storage electrode lines 131 are supplied with a predetermined voltage, and each of the storage electrode lines 131 includes a stem extending substantially parallel to the gate lines 121 and a plurality of pairs of storage electrodes 133a and 133b branched from the stem. Each of the storage electrode lines 131 is disposed between two adjacent gate lines 121. The stem is formed close to one of the two adjacent gate lines 121. Each of the storage electrodes 133a and 133b has a fixed end portion connected to the stem and a free end portion disposed opposite thereto. The fixed end portion of the storage electrode 133b has an area. The free end portion is bifurcated into a linear branch and a curved branch. According to embodiments of the present invention, the storage electrode lines 131 may have various shapes and arrangements.

The gate lines 121 and the storage electrode lines 131 may comprise, for example, an Al-containing metal such as Al and an Al alloy, an Ag-containing metal such as Ag and an Ag alloy, a Cu-containing metal such as Cu and a Cu alloy, a Mo-containing metal such as Mo and a Mo alloy, Cr, Ta, or Ti. In an embodiment of the present invention, the gate lines 121 and the storage electrode lines 131 may have a multi-layered structure including two conductive films (not shown) having different physical characteristics. One of the two films may comprise, for example, a low resistivity metal such as an Al-containing metal, an Ag-containing metal, and a Cu-containing metal for reducing signal delay or voltage drop. The other film may comprise, for example, a material such as a Mo-containing metal, Cr, Ta, or Ti, which have good physical, chemical, and electrical contact characteristics with other materials such as, for example, indium tin oxide (ITO) or indium zinc oxide (IZO). Examples of the combination of the two films can be a lower Cr film and an upper Al (alloy) film and a lower Al (alloy) film and an upper Mo (alloy) film. In embodiments of the present invention, the gate lines 121 and the storage electrode lines 131 may comprise various metals or conductors.

The lateral sides of the gate lines 121 and the storage electrode lines 131 are inclined relative to a surface of the insulating substrate 110, and the inclination angle thereof ranges about 30 degrees to about 80 degrees.

A gate insulating layer 140 comprising, for example, silicon nitride (SiNx) or silicon oxide (SiOx) is formed on the gate lines 121 and the storage electrode lines 131.

A plurality of semiconductor stripes 151 comprising, for example, hydrogenated amorphous silicon (“a-Si”) or polysilicon are formed on the gate insulating layer 140. The semiconductor stripes 151 extend substantially in the longitudinal direction and become wide near the gate lines 121 and the storage electrode lines 131 such that the semiconductor stripes 151 cover areas of the gate lines 121 and the storage electrode lines 131. Each of the semiconductor stripes 151 includes a plurality of projections 154 branched out toward the gate electrodes 124.

A plurality of ohmic contact stripes and islands 161 and 165 are formed on the semiconductor stripes 151. The ohmic contact stripes and islands 161 and 165 may comprise, for example, n+ hydrogenated a-Si heavily doped with an n-type impurity such as phosphorous or silicide. Each ohmic contact stripe 161 includes a plurality of projections 163. The projections 163 and the ohmic contact islands 165 are located in pairs on the projections 154 of the semiconductor stripes 151.

The lateral sides of the semiconductor stripes 151 and the ohmic contact stripes and islands 161 and 165 are inclined relative to the surface of the substrate 110, and the inclination angles thereof can be in a range of about 30 degrees to about 80 degrees.

A plurality of data lines 171 and a plurality of drain electrodes 175 are formed on the ohmic contact stripes and islands 161 and 165 and the gate insulating layer 140.

The data lines 171 transmit data signals and extend substantially in the longitudinal direction to intersect the gate lines 121. Each data line 171 also intersects the storage electrode lines 131 and is positioned between adjacent pairs of storage electrodes 133a and 133b. Each data line 171 includes a plurality of source electrodes 173 projecting toward the gate electrodes 124 and being curved in the shape of a crescent, and an end portion 179 having an area for contacting with another layer or an external driving circuit. A data driving circuit (not shown) for generating the data signals may be mounted on an FPC film (not shown). The FPC film may be attached to the insulating substrate 110, be directly mounted on the insulating substrate 110, or be integrated onto the insulating substrate 110. The data lines 171 may be connected to a driving circuit that may be integrated on the insulating substrate 110.

The drain electrodes 175 are separated from the data lines 171 and disposed opposite the source electrodes 173 with respect to the gate electrodes 124. Each of the drain electrodes 175 includes a wide end portion and a narrow end portion. The wide end portion overlaps a storage electrode line 131 and the narrow end portion is partly overlapped by a source electrode 173.

The gate electrode 124, the source electrode 173, and the drain electrode 175 along with the projection 154 of the semiconductor stripe 151 form a TFT having a channel formed in the projection 154 disposed between the source electrode 173 and the drain electrode 175.

The data lines 171 and the drain electrodes 175 may comprise, for example, a refractory metal such as Cr, Mo, Ta, Ti, or alloys thereof. In an embodiment of the present invention, the data lines 171 and the drain electrodes 175 may have a multilayered structure including, for example, a refractory metal film (not shown) and a low resistivity film (not shown). Examples of the multi-layered structure are a double-layered structure including a lower Cr/Mo (alloy) film and an upper Al (alloy) film, and a triple-layered structure of a lower Mo (alloy) film, an intermediate Al (alloy) film, and an upper Mo (alloy) film. Alternatively, the data lines 171 and the drain electrodes 175 may comprise various metals or conductors.

The data lines 171 and the drain electrodes 175 have inclined edge profiles. The inclination angles thereof range from about 30 degrees to about 80 degrees.

The ohmic contact stripes and islands 161 and 165 are interposed between the underlying semiconductor stripes 151 and the overlying conductors such as the data lines 171 and the drain electrode 175 to reduce the contact resistance therebetween. Although the semiconductor stripes 151 are narrower than the data lines 171 at most places, the width of the semiconductor stripes 151 becomes large near the gate lines 121 and the storage electrode lines 131 as described above, to smooth the profile of the surface, thereby preventing disconnection of the data lines 171. The semiconductor stripes 151 may have almost the same planar shapes as the data lines 171 and the drain electrodes 175 as well as the underlying ohmic contact stripes and islands 161 and 165. In an embodiment of the present invention, the semiconductor stripes 151 include some exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor stripes 151. The passivation layer 180 may comprise, for example, an inorganic or organic insulator. The passivation layer 180 may have a flat top surface. Examples of the inorganic insulator include silicon nitride and silicon oxide. The organic insulator may have photosensitivity and a dielectric constant of less than about 4.0. The passivation layer 180 may include a lower film of an inorganic insulator and an upper film of an organic insulator such that the passivation layer 180 has enhanced insulating characteristics of the organic insulator while preventing the exposed portions of the semiconductor stripes 151 from being damaged.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the storage electrodes 133b, and a plurality of contact holes 183b exposing the linear branches of the free end portions of the storage electrodes 133b.

A plurality of pixel electrodes 191, a plurality of overpasses 83, and a plurality of contact assistants 81 and 82 are formed on the passivation layer 180, and may comprise, for example, a transparent conductor such as ITO or IZO, a reflective conductor such as Ag, Al, Cr, or alloys thereof.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of the opposing color filter panel 200 supplied with a common voltage. The electric fields determine the orientations of liquid crystal molecules (not shown) of the liquid crystal layer 3 disposed between the TFT array panel 100 and the color filter panel 200. A pixel electrode 191 and the common electrode 270 form a capacitor referred to as a “liquid crystal capacitor,” which stores applied voltages after the TFT turns off.

The pixel electrode 191 overlaps the storage electrode line 131 including the storage electrodes 133a and 133b. The pixel electrode 191 and the drain electrode 175 connected thereto and the storage electrode line 131 form an additional capacitor referred to as a “storage capacitor,” which enhances the voltage storing capacity of the liquid crystal capacitor.

The pixel electrode 191 overlaps adjacent gate line 121 and data line 171 to increase the aperture ratio.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices. The contact assistants 81 and 82 may be connected to external devices via anisotropy conductive films (not shown).

When the gate driving circuit (not shown) is integrated into the insulating substrate 110, the contact assistants 81 may be used to connect a metal layer of the gate driving circuit and the gate lines 121. Similarly, when the data driving circuit (not shown) is integrated into the insulating substrate 110, the contact assistants 82 may be used to connect a metal layer of the data driving circuit and the data lines 171.

The overpasses 83 cross over the gate lines 121 and are connected to the exposed portions of the storage electrode lines 131 and the exposed linear branches of the free end portions of the storage electrodes 133b through the contact holes 183a and 183b, respectively, which are disposed opposite each other with respect to the gate lines 121. The storage electrode lines 131 including the storage electrodes 133a and 133b along with the overpasses 83 can be used for repairing defects in the gate lines 121, the data lines 171, or the TFTs.

Referring to FIGS. 2 to 4, a light blocking member 220 referred to as a black matrix for preventing light leakage is formed on an insulating substrate 210. The light blocking member 220 includes a plurality of openings 225 that face the pixel electrodes 191, and may have substantially the same planar shape as the pixel electrodes 191. In an embodiment of the present invention, the light blocking member 220 may include a plurality of rectilinear portions facing the data lines 171 on the TFT array panel 100 and a plurality of widened portions facing the TFTs on the TFT array panel 100.

The insulating substrate 210 may comprise a flexible material such as, for example, plastic suitable for manufacturing flexible LCDs. For example, the insulating substrate 210 includes a layer comprising one material selected from polyacrylate, polyethylene-terephthalate, polyethylene-naphthalate, polycarbonate, polyarylate, polyether-imide, polyethersulfone, or polyimides.

A plurality of color filters 230 are formed on the insulating substrate 210, and are disposed substantially in the areas enclosed by the light blocking member 220. The color filters 230 may extend substantially in the longitudinal direction along the pixel electrodes 191. The color filters 230 may represent one of the primary color such as red, green, and blue.

An overcoat 250 is formed on the color filters 230 and the light blocking member 220. The overcoat 250 may comprise, for example, an (organic) insulator and prevents the color filters 230 from being exposed. The overcoat 250 can be used to provide a flat surface. Alternatively, the overcoat 250 may be omitted.

A common electrode 270 is formed on the overcoat 250. The common electrode 270 may comprise, for example, a transparent conductive material such as ITO and IZO, and is supplied with the common voltage.

Alignment layers 11 and 21 that may be horizontal or vertical alignment layers are coated on inner surfaces of the TFT array panel 100 and the color filter panel 200. Polarizers 12 and 22 are provided on outer surfaces of the TFT array panel 100 and the color filter panel 200 so that their polarization axes may cross and one of the polarization axes may be parallel to the gate lines 121. In an embodiment of the present invention, one of the polarizers 12 and 22 may be omitted when the LCD is a reflective type LCD.

The LCD may further include at least one retardation film (not shown) for compensating the retardation of the LC layer 3.

The retardation film is birefringent and inversely compensates the birefringence of the LC layer 3. The retardation film may use a uniaxial or biaxial optical film, and it may use, for example, a negative uniaxial optical film.

The LCD may further include a backlight unit (not shown) supplying light to the LC layer 3 through the polarizers 12 and 22, the retardation film, and the TFT array panel 100 and the color filter panel 200.

Now, a method of manufacturing the TFT array panel shown in FIGS. 1 and 3 to 5 according to an embodiment of the present invention will be described.

Referring to FIGS. 3 to 5, a metal film is sputtered on an insulating substrate 110 comprising flexible a material such as, for example, plastic. The metal film is patterned by wet etching or dry etching with a photoresist pattern to form a plurality of gate lines 121 including a plurality of gate electrodes 124 and an end portion 129 and a plurality of storage electrodes 131 having a pair of storage electrodes 133a and 133b.

After sequential deposition of the gate insulating layer 140, an intrinsic a-Si layer, and an extrinsic a-Si layer, the extrinsic a-Si layer and the intrinsic a-Si layer are photo-etched to form a plurality of ohmic contact (extrinsic semiconductor) stripes 161 and a plurality of intrinsic semiconductor stripes 151 including the plurality of projections 154 on the gate insulating layer 140. The gate insulating layer 140 has a thickness of about 1,500 Å to about 5,500 Å. The intrinsic a-Si layer has a thickness of about 500 Å to about 2,000 Å. The extrinsic a-Si layer has a thickness about 300 Å to about 600 Å.

A conductive layer is sputtered to have a thickness of about 1,500 Å to about 3,000 Å. The conductive layer is patterned by etching with a photoresist pattern to form a plurality of data lines 171 including a plurality of source electrodes 173, an end portion 179 and a plurality of drain electrodes 175.

Portions of the extrinsic a-Si layer which are not covered with the data lines 171 and the drain electrodes 175 are removed by etching to complete a plurality of ohmic contact stripes 161 including a plurality of projections 163 and a plurality of ohmic contact islands 165, and to expose portions of the intrinsic semiconductor stripes 151. Oxygen plasma treatment may follow thereafter to stabilize the exposed surfaces of the semiconductor stripes 151.

A passivation layer 180 comprising, for example, positive photosensitive organic materials is deposited on the data lines 171, the drain electrodes 175, and the exposed semiconductor stripes 151.

The passivation layer 180 is exposed to light through a photo mask. The photo mask includes a transparent substrate and an opaque light blocking film, and is divided into light transmitting areas, light blocking areas, and translucent areas. The light blocking film is not disposed on the light transmitting areas, but is disposed on the light blocking areas and the translucent areas. The light blocking film includes a wide area having a width larger than a predetermined value on the light blocking areas, and includes a plurality of areas having width or distance smaller than a predetermined value to form slits.

The passivation layer 180 is developed to form a plurality of contact holes 182 and 185 exposing the end portions 179 of the data lines 171 and the drain electrodes 175. The passivation layer 180 is also developed along with the gate insulating layer 140 to form the contact holes 181, 183a, and 183b exposing the end portions 128 of the gate lines 121 and the storage electrodes 133a and 133b of the storage electrode lines, respectively.

When the passivation layer 180 comprises, for example, negative photosensitive materials, the positions of the light transmitting areas and the light blocking areas of the photo mask are changed with each other.

IZO or ITO with a thickness of about 400 Å to about 500 Å is sputtered and etched to form a plurality of pixel electrodes 191, a plurality of contact assistants 81 and 82, and overpasses 83 on the passivation layer 180, the exposed drain electrodes 175, the end portions 179 of the data lines 171, the end portions 129 of the gate lines 121, and the exposed storage electrode lines 131.

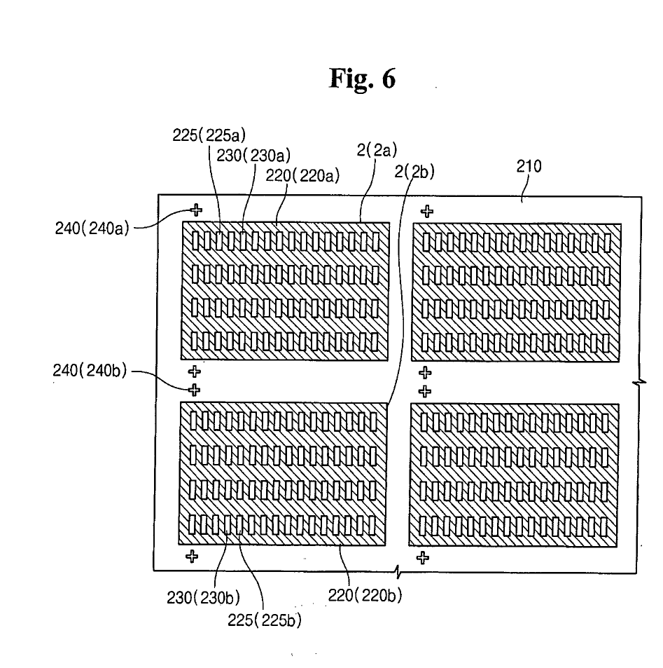

Next, a manufacturing method of the color filter 200 according to an embodiment of will be described in detail with reference to FIGS. 6 and 8 as well as FIGS. 2 to 4.

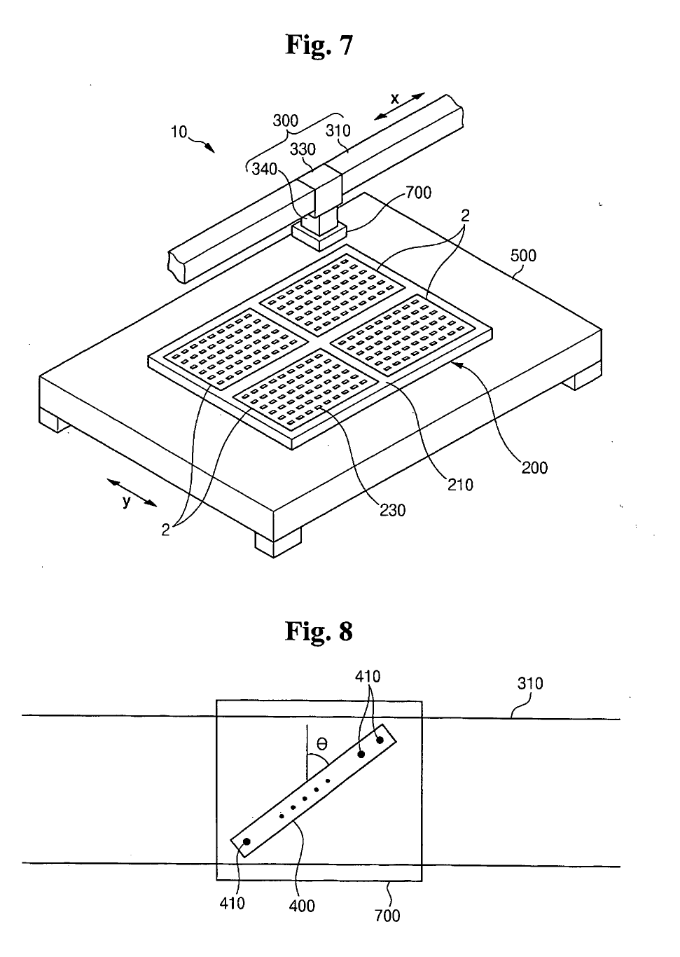

FIG. 6 illustrates alignment keys formed on a flexible substrate having a plurality of unit cells for explaining a manufacturing method of the color filter array panel according to an embodiment of the present invention, FIG. 7 is a perspective view of an inkjet printing device according to an embodiment of the present invention, and FIG. 8 is a bottom view of an inkjet head of the inkjet printing device according to an embodiment of the present invention.

The inkjet printing device 10 for forming the color filters 230 on the color filter panel 200 according to an embodiment of the present invention is described below.

Referring to FIG. 7 and FIG. 8, the inkjet printing device 10 includes a stage 500 on which an insulating substrate 210 of a color filter panel 200 is provided, a head unit 700, and a transporting unit 300 that transports the head unit 700 to a predetermined position.

The head unit 700 includes an inkjet head 400 and at least one ink supply nozzle 410 attached to or connected with the inkjet head 400. The head unit 700 ejects ink through the ink supply nozzles 410 to color filters 230 on the insulating substrate 210.

For forming the color filters 230 on the insulating substrate 210 arranged on the stage 500, the head unit 700 ejects ink through the supply nozzles 410 as the transporting unit 300 transports the head unit 700 in an X direction. Thus, the ink is ejected on the insulating substrate 210 to form the color filters 230 thereon. The size of the insulating substrate 210 may be increased, but the number of the supply nozzles 410 and the size of the inkjet head 400 are limited. Thus, the entire color filters 230 are not completely formed by a single scan. To completely form the entire color filters 230, the head unit 700 is transported repeatedly in X and Y direction.

The transporting unit 300 includes a supporting unit 310 to keep the head unit 700 spaced apart at a predetermined distance from the insulating substrate 210, a transporting portion 330 for transporting the head unit 700 in X and Y directions, and an elevating unit 340 for elevating the head unit 700.

The inkjet head 400 of the head unit 700 supports the ink supply nozzles 410 and may include three heads for red, green, and blue, respectively. The inkjet head 400 may have, for example, a long bar shape. The ink supply nozzles 410 may be provided on the entire surface of the inkjet head 400.

For example, when there are three heads, each head is spaced apart by an equal distance and is parallel with each other. A plurality of heads may be separately arranged by horizontal movement, vertical movement, and rotation.

The inkjet head 400 is inclined to a predetermined angle θ with respect to the Y direction. For example, since a nozzle pitch (i.e., a distance between adjacent nozzles) is different from a pixel pitch (i.e., a distance between adjacent pixels to be printed), by rotating the inkjet head 400 to the predetermined angle θ, an interval between adjacent ink ejected through the nozzles 410 and the pixel pitch may correspond.

Instead of moving the inkjet head 400 using the head unit 700, the stage 500 may be moved to accurately eject ink into corresponding positions.

A manufacturing method of the color filter panel 200 using the inkjet printing device 10 according to an embodiment of the present invention is described below.

Referring to FIG. 6, a metal film such as, for example, Cr is deposited by plasma enhanced chemical vapor deposition (PECVD), and is patterned by photo-etching with a photoresist pattern to form the light blocking member 220. Alternatively, the light blocking member 220 may be formed by spin coating of high polymer resin liquid or by other various methods.

The light blocking member 220 has a plurality of openings 225 and can be used as side walls sealing ink for the color filters 230 therein.

The ink for the color filters 230 is ejected into the corresponding openings 225 using the inkjet printing device 10 to form the color filters 230.

That is, by moving the stage 500 or the inkjet head 400 of the inkjet printing device 10, the ink is ejected into the openings 225 through the supply nozzles 410 of the inkjet head 400. The ink may include three primary color such as red, green, and blue. Therefore, red ink is ejected into openings 225 corresponding to the color filters 230 for the red, green ink is ejected into openings 225 corresponding to the color filters 230 for the green, and blue ink is ejected into openings 225 corresponding to the color filters 230 for the blue. The inkjet printing device 10 adjusts the position of the stage 500 with the inkjet head 400 using at least one alignment key 240 formed around the outer block of the light blocking member 220.

The alignment key 240 may have a cross shape or other various shapes.

The inkjet printing device 10 aligns the position of the stage 500 with the inkjet head 400 based on the difference between a predetermined reference position and the position of the alignment key 240.

In FIG. 6, the alignment key 240 is formed on the outside of the light blocking member 220. Alternatively, the alignment key 240 may be formed on the edge of the light blocking member 220.

The intervals between the ink supply nozzles 410 and the intervals between the color filters 230 are respectively constant. The intervals of ink ejected through the ink supply nozzles 410 are similar to those of the openings 225 of the light blocking member 220. Therefore, when the position of the ink supply nozzles 410 of the inkjet head 400 is exactly adjusted using the alignment key 240, the ink can be accurately ejected into the corresponding openings 225 of the light blocking member 220.

When the number of the alignment key 240 increases, the productivity of the LCD is improved. Alternatively, the alignment key 240 may be formed on the basis of red color filters, green color filters, and blue color filters, respectively.

The formation manner of the alignment key 240 may be varied in accordance with characteristics of the inkjet printing device 10 or ink ejecting methods.

When the light blocking member 220 comprises organic materials, the alignment key 240 is formed along with the openings 225 of the light blocking member 220. In an embodiment of the present invention, when the light blocking member 220 comprises inorganic materials, after forming the openings 225 of the light blocking member 220 the alignment key 240 is formed thereon. That is, a photoresist film is deposited on the light blocking member 220 having openings 225 and exposed, developed, and etched to form the alignment key 240 on the light blocking member 220.

The alignment key 240 is formed around every unit cell 2, and the alignment of the inkjet head 400 or the stage 500 is thereby conducted. That is, the inkjet head 400 and the stage 500 is aligned based on an alignment key 240a corresponding to a unit cell 2a. Ink is ejected into the corresponding openings 225a formed in the light blocking member 220a via the ink supply nozzles 410 of the inkjet head 400 to form the color filters 230a.

The inkjet head 400 and the stage 500 is realigned based on another alignment key 240b corresponding to a unit cell 2b. Ink is ejected into the corresponding openings 225b formed in the light blocking member 220b via the ink supply nozzles 410 of the inkjet head 400 to form the color filters 230b.

As described above, by using the inkjet printing device 10 to form the color filters 230 on the color filter panel 200 having the flexible insulating substrate 210, the photo etching processes which cause transformation of the flexile substrate 210 are not required. Accordingly, pattern misalignment due to the transformation of the flexible insulating substrate 210 during the photo etching processes does not occur.

Since the alignment operation of the inkjet head 400 and the stage 500 is repeated for every unit cell, the pattern misalignment due to the transformation of the flexible insulating substrate 210 by the heat and humidity does not occur.

The color filter panel 200 according to an embodiment of the present invention can be applied to organic light emitting panels of organic light emitting displays (OLEDs).

According to embodiments of the present invention, since the inkjet printing device is used for forming the color filters on the color filter panel, the photo etching processes are not required for forming the color filters, and thereby the amount of the transformation of the flexile substrate is decreased. Accordingly, the pattern misalignment due to the transformation of the flexible substrate does not occur.

Since the alignment operation of the inkjet head and the stage is repeated for every unit cell, the pattern misalignment due to the transformation of the flexible substrate by the heat and humidity does not occur.

Although the exemplary embodiments of the present invention have been described with reference to the accompanying drawings, it is to be understood that the present invention should not be limited these precise embodiments but various changes and modifications can be made by one ordinary skill in the art without departing from the spirit and scope of the present invention. All such changes and modifications are intended to be included with the scope of the invention as defined by the appended claims.

What is claimed is:

1. A method of manufacturing a color filter panel using an inkjet printing device including a stage and an inkjet head, the method comprising:
mounting a flexible substrate on the stage;
forming at least one alignment key and a light blocking member having a plurality of openings on the flexible substrate;
aligning the inkjet head with the stage on the basis of the at least one alignment key; and
ejecting ink through the inkjet head into the openings of the light blocking member to form color filters.

2. The method of claim 1, wherein the flexible substrate comprises a plurality of unit cells and the at least one alignment key is formed around every unit cell.

3. The method of claim 1, wherein the flexible substrate comprises a plurality of unit cells and the at least one alignment key is formed on an edge of every unit cell.

4. The method of claim 1, wherein the alignment of the inkjet head with the stage is repeated for every unit cell.

5. The method of claim 1, wherein the color filters include color filters for red, green, and blue, and the at least one alignment key is formed based on the color filters for red, green, and blue, respectively.

6. The method of claim 1, wherein the flexible substrate comprises one material selected from polyacrylate, polyethylene-terephthalate, polyethylene-naphthalate, polycarbonate, polyarylate, polyether-imide, polyethersulfone, or polyimides.

7. The method of claim 1, further comprising forming an overcoat on the color filters and the light blocking member, and forming a common electrode on the overcoat.

8. The method of claim 1, wherein the inkjet head comprises a plurality of nozzles, and the ink is ejected through the nozzles.

9. The method of claim 1, wherein the light blocking member and the at least one alignment key are formed by photo etching.

10. The method of claim 1, wherein the inkjet head is inclined at a predetermined angle so that an interval between adjacent ink ejected through the inkjet head corresponds to a pixel pitch .

11. A method of manufacturing a liquid crystal display (LCD) comprising:
forming a thin film transistor (TFT) array panel;
forming a color filter panel opposite the TFT array panel; and
disposing a liquid crystal layer between the TFT array panel and the color filter panel,
wherein the formation of the color filter panel comprises:
mounting a flexible substrate on a stage;
forming at least one alignment key and a light blocking member having a plurality of openings on the flexible substrate;
aligning the inkjet head with the stage on the basis of the at least one alignment key; and
ejecting ink through the inkjet head into the openings of the light blocking member to form color filters.

12. The method of claim 11, wherein the flexible substrate comprises a plurality of unit cells, and at least one alignment key is formed around every unit cell.

13. The method of claim 11, wherein the flexible substrate comprises a plurality of unit cells, and at least one alignment key is formed on an edge of every unit cell.

14. The method of claim 11, wherein the alignment of the inkjet head with the stage is repeated for every unit cell.

15. The method of claim 11, wherein the flexible substrate comprises one material selected from polyacrylate, polyethylene-terephthalate, polyethylene-naphthalate, polycarbonate, polyarylate, polyether-imide, polyethersulfone, or polyimides.

16. An inkjet printing device, comprising:
a head unit including an inkjet head for ejecting ink;
a transporting unit, coupled with the head unit, for transporting the head unit in a first direction and a second direction; and
a stage for receiving a color filter panel having an insulating substrate, the stage transporting the color filter panel in the first direction and the second direction,
wherein alignment keys to align the transporting unit with the stage are formed on the insulating substrate.

17. The inkjet printing device of claim 16, wherein the first direction and the second direction are perpendicular to each other.

18. The inkjet printing device of claim 16, wherein the inkjet head is inclined in a predetermined angle.

19. The inkjet printing device of claim 16, wherein the alignment keys are formed in cross shapes.
